(19) United States
(12) Patent Application Publication
(10) Pub. No.: US 2015/0226934 A1
(43) Pub. Date: Aug. 13, 2015

(54) FOCUS ADJUSTMENT APPARATUS HAVING FRAME-OUT PREVENTIVE CONTROL, AND CONTROL METHOD THEREFOR

(71) Applicant: CANON KABUSHIKI KAISHA, Tokyo (JP)

(72) Inventor: Naoki Iwasaki, Kawasaki-shi (JP)

(21) Appl. No.: 14/614,027

(22) Filed: Feb. 4, 2015

(30) Foreign Application Priority Data
Feb. 7, 2014 (JP) 2014-022453

(51) Int. Cl. G02B 7/09; G03B 13/36

(52) U.S. Cl. CPC G02B 7/09; G03B 13/36

(57) ABSTRACT

A focus adjustment apparatus recaptures an object even if the object goes out of a view angle during imaging. The apparatus performs a zoom control of detecting a movement condition of a camera and automatically shifts a zoom position to a wide angle side or a telephoto side on the basis of the movement condition. The zoom position and a focus position before the zoom position is shifted to the wide angle side are stored. A focal point adjustment is performed to bring the object into focus by moving a focus lens to a target position. When the zoom position is moved to the telephoto side, the stored zoom position is used as the target position. When the zoom position is being shifted to the wide angle side, the object is brought into focus by moving the focus lens and the stored focus position is used as the target position.

### BACKGROUND OF THE INVENTION

1. Field of the Invention

The present invention relates to a focal point adjustment apparatus and a control method for the apparatus. More particularly, the present invention relates to an autofocus apparatus having frame-out preventive control used in image-capturing apparatuses, such as electronic still cameras, video cameras, and the like.

2. Description of the Related Art

Conventionally, when autofocus (also referred to as “AF”) is performed in an electronic still camera, a video camera, etc., a method has been used in which a lens position at which the high frequency component of a luminance signal obtained from an imaging sensor that uses a charged-couple device (CCD) or the like becomes maximum is determined as a in-focus position.

Among AF methods, a following scan method is known. That is, while a focus lens is being driven over the entire focal point detection range, every evaluation value based on the high frequency component of the luminance signal obtained from an imaging sensor (also referred to as focal point evaluation value) is stored when the evaluation value is obtained. Then, a lens position that corresponds to the maximum value among the stored values is determined as an in-focus position.

Furthermore, a hill-climbing method (a so-called continuous autofocus (AF) and, hereinafter, referred to also as continuous AF) has been known in which a focus lens is moved in such a direction that the focal point evaluation value increases, and the position at which the focal point evaluation value becomes maximum is determined as an in-focus position.

Furthermore, there is a technology related to a zoom function that supports view angle adjustment for the convenience of a user. Specifically, in an imaging apparatus having a high-magnification zoom function, if an object moves even slightly at the time of view angle adjustment in a telephoto state, the object can fall out of (exit) the frame. Furthermore, even if the object does not move, a slight movement of the camera due to hand-shaking, wind or the like, for example, will shift the view angle and cause the object to exit the frame. Therefore, methods in which an object having gone out of the frame can be recaptured by a simple operation have been previously proposed.

In conjunction with the AF technology and the technology related to the zoom function that supports view angle adjustment, there has been proposed a method in which at the time of view angle adjustment, the zoom lens is driven toward the wide angle side up to a predetermined position, and then the continuous AF is stopped so as to reduce defocus. This is discussed in Japanese Patent Application Laid-Open No. 2012-58587.

There is also a method in which before the zoom lens is driven to a predetermined position at the time of view angle adjustment, AF is performed so as to reduce defocus in a live view. This is disclosed in Japanese Patent Application Laid-Open No. 2011-257699.

However, the camera described in Japanese Patent Application Laid-Open No. 2012-58587 cannot focus on a moving object if the zoom lens continues to be held at the wide angle side. Therefore, in the camera of Japanese Patent Application Laid-Open No. 2011-257699, depending on the mechanical configuration of the zoom lens, if the zoom lens is driven to the telephoto side, when the focus has been adjusted again at the wide angle side, a great defocus may sometimes result.

### SUMMARY OF THE INVENTION

The various embodiments of the present invention are directed to capturing again, by a simple operation, an object having gone out of the view angle at the time of telephoto imaging, and to focus on the object while assisting in view angle adjustment even when the object moves in a range of directions during the view angle adjustment.

According an aspect of the present invention, a focus adjustment apparatus includes a control unit configured to shift a zoom position to a wide angle side according to a first operation condition of the focal point adjustment apparatus, and to shift the zoom position to a telephoto side according to a second operation condition of the apparatus, a storage unit configured to store the zoom position and a focus position when the zoom position is shifted to the wide angle side by the control unit, and a focal point adjustment unit configured to bring an object into focus by moving a focus lens to a target position. When the zoom position is moved to the telephoto side by the control unit, the zoom position stored in the storage unit is used as the target position. When the zoom position is being shifted to the wide angle side by the control unit, the focal point adjustment unit brings the object into focus by moving the focus lens and uses as the target position the focus position stored in the storage unit.

Further features of the present invention will become apparent from the following description of exemplary embodiments (with reference to the attached drawings).

### BRIEF DESCRIPTION OF THE DRAWINGS

FIG. 1 is a block diagram illustrating a configuration of an imaging apparatus for which an automatic focusing apparatus according to an exemplary embodiment of the present invention is employed.

FIG. 2 is flowchart illustrating an operation of a frame-out preventive control in the automatic focusing apparatus.

FIG. 3A presents a flowchart illustrating an operation of continuous AF.

FIG. 3B presents a flowchart illustrating an operation of continuous AF.

FIG. 4 is a flowchart illustrating an operation of an imaging process.

FIG. 5 is a flowchart illustrating an operation of AF for main exposure.

FIG. 6 is a flowchart illustrating an operation of AF scan for main exposure.

FIG. 7 is a flowchart illustrating an operation of a main exposure process.

FIGS. 8A to 8E illustrate an example of an object of which a camera is capturing an image.

FIG. 9 is a flowchart illustrating an operation of initial state setting.

### DESCRIPTION OF THE EMBODIMENTS

With reference to the drawings, an electronic camera (hereinafter, referred to as camera) will be described hereinafter as an example of an imaging apparatus for which an automatic focusing (AF) apparatus according to the present invention is employed.

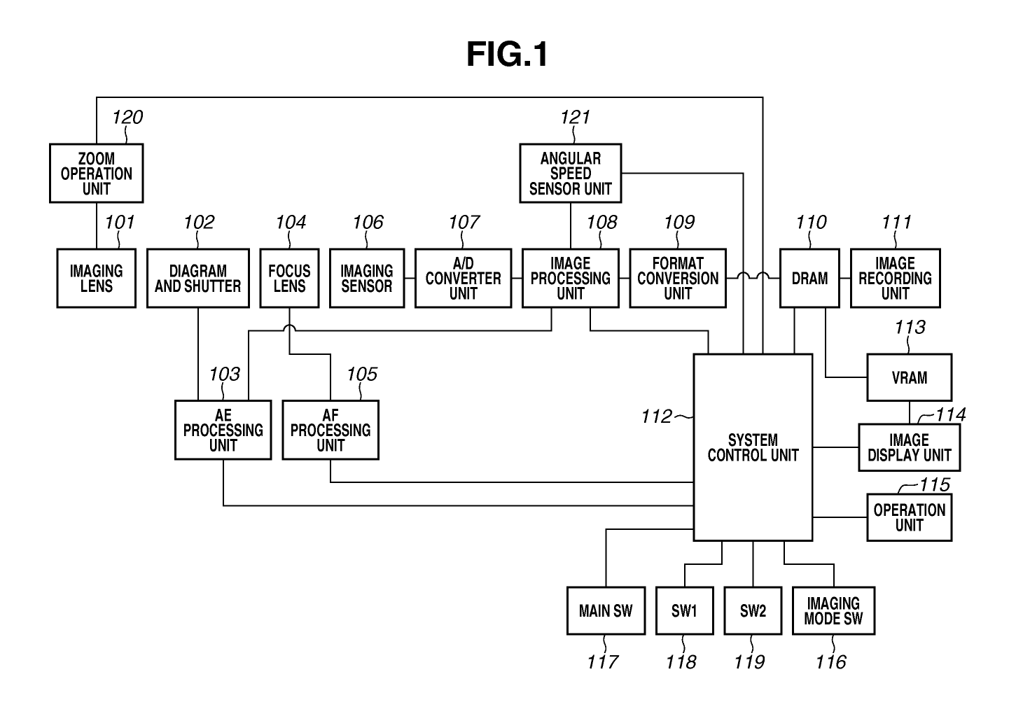

FIG. 1 is a block diagram illustrating a structural and functional configuration of the camera.

The camera has an imaging lens 101 that includes a zoom mechanism, a diaphragm and shutter 102 that controls the amount of light, an auto-exposure (AE) processing unit 103, a focus lens 104 for adjusting a focal point on an imaging sensor, and an autofocus (AF) processing unit 105 as an example of a focal point adjustment unit.

The camera has an imaging sensor 106 that performs photoelectric conversion of a subject image obtained through a focus lens and outputs a video signal obtained by the photoelectric conversion. An example of the imaging sensor 106 includes, but is not limited to, a CMOS sensor, a CCD sensor, or the like. Furthermore, the camera has an analog-to-digital (A/D) conversion unit 107 that includes a correlated double sampling (CDS) circuit that removes output noise as well as a non-linear amplifier circuit that operates prior to the A/D conversion, and also has an image processing unit 108, and a format conversion unit 109. Concretely, the imaging sensor 106 outputs a video signal by converting reflection light from an object into an electrical signal.

Furthermore, the camera also has a built-in high speed memory (e.g., a random-access memory, etc., which will be hereinafter referred to as “DRAM”) 110, an image recording unit 111 made up of a recording medium, such as a memory card, and an interface for the recording medium, and a system control unit 112 (microcontroller) that controls a system, e.g., controls an imaging sequence. The DRAM 110 is used as a high-speed buffer for temporarily storing images, a working memory for compression and decompression of an image, etc. The system control unit 112 is a so-called computer, and includes a CPU and a memory. The camera may also have a memory that stores programs that the system control unit 112 executes.

The camera further has a memory for image display (hereinafter, referred to as VRAM) 113, an operation display unit 114 that displays an image, produces a display for assisting the user's operation and a display for indicating the state of the camera, and, at the time of imaging, displays an imaging screen and an AF region, and an operation unit 115 used for operating the camera from outside. The operation unit 115 includes, for example, components as follows. That is, the operation unit 115 includes a menu switch for making various settings, such as a setting of the camera's imaging function or a setting for image reproduction, a zoom lever for giving a command to zoom the imaging lens 101, a switch for changing the operation mode between an imaging mode and a reproduction mode, etc.

Further, the camera also has an imaging mode switch 116 for making a setting, for example, switching a face detection mode between the on and off-states, and a main switch 117 for inputting power to the system.

The camera further has a switch (hereinafter, referred to as SW1) 118 for an imaging standby operation, such as AF and AE, and an imaging switch (hereinafter, referred to as SW2) 119 for performing imaging after operation of the SW1 118. Concretely, half-pressing the imaging switch 119 turns on the SW1 118, and full-pressing the imaging switch 119 turns on the SW2 119.

Furthermore, the camera according to this exemplary embodiment has a zoom operation unit 120 for assisting in view angle adjustment. By operating the zoom operation unit 120, an operator (user) can easily carry out view angle adjustment. Operations that camera performs when the zoom operation unit 120 is operated will be described below. Furthermore, an angular speed sensor unit 121 detects movement of the camera, and sends camera movement information to the system control unit 112. Using this angular speed sensor unit 121, it is also possible to detect whether the camera is being held in a vertical position or a horizontal position.

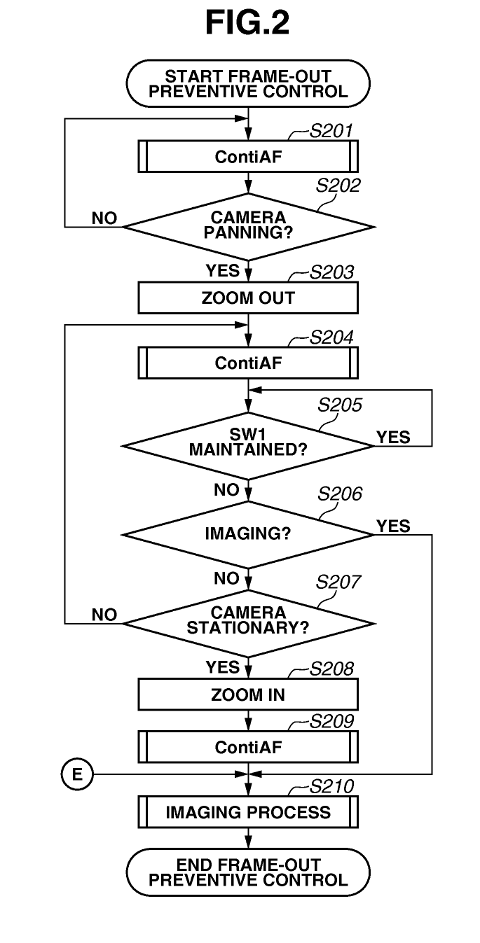

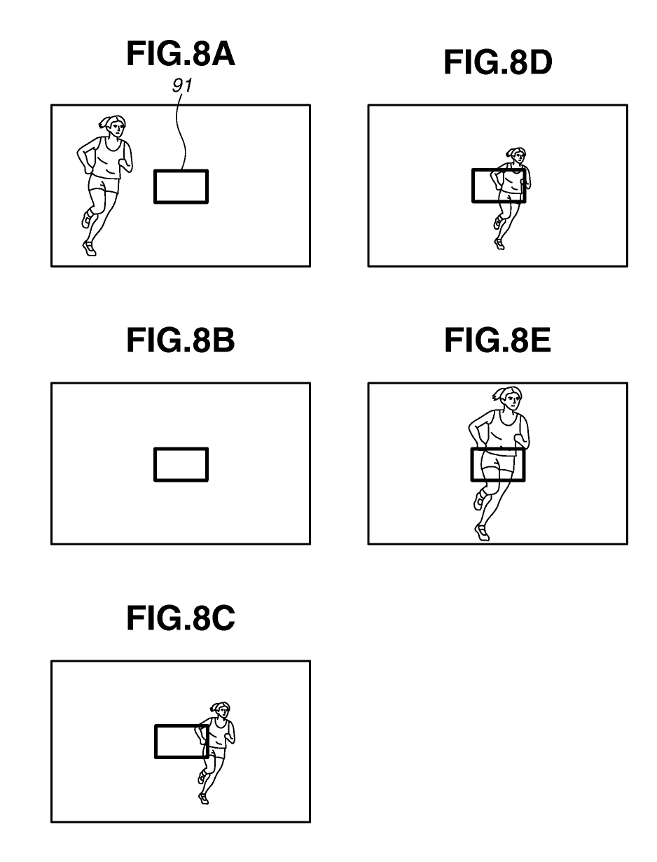

Next, a focusing control and an imaging operation of the camera will be described with reference to a flowchart in FIG. 2, and FIGS. 8A to 8E. The flowchart presented in FIG. 2 illustrates a frame-out preventive control that is realized when the system control unit 112 executes a program stored in the memory. Whether this frame-out preventive control is in an effective state or in an ineffective state can be switched by the imaging mode switch 116. FIGS. 8A to 8E present an example of an object (human subject) of which the camera is capturing an image. In this example, as illustrated in FIG. 8A, the operator, using the zoom lever, enlarges the object by performing a zoom operation (zooming to the telephoto side). A frame at the center in each of FIGS. 8A to 8E indicates an AF frame 91 as described below.

Firstly, in step S201, the system control unit 112 performs continuous AF, following a procedure as described below. Next, in step S202, the system control unit 112 determines, via the angular speed sensor unit 121, a camera movement state (operation condition), such as whether the camera is being panned by the operator. In a product embodiment, the state where the camera is being moved (panning) is a state where an output obtained by the angular speed sensor unit 121 becomes equal to or greater than a predetermined threshold value. If a movement of the camera is detected, the process proceeds to step S203. If the camera is not being moved, the process returns to step S201, in which the continuous AF is continued. Here, when a movement of the camera is detected (YES in S202), it is, for example, the case where the zoom lens position (zoom position) is at the telephoto side and where when the operator merely slightly moves the camera, an object goes far out of the view angle as illustrated in FIG. 8B, so that a panning operation is performed in order to search for the object.

In step S203, the system control unit 112 moves the position of the zoom lens to a wide angle side (zoom out operation), in order to facilitate the view angle adjustment. To move the zoom lens position to the wide angle side, a so-called computer zoom (camera trace) operation of controlling the focus lens 104 so as to correct the image surface movement involved in a movement of the zoom lens on the basis of camera track information stored in a camera track storage unit (not illustrated) is performed. The system control unit 112 stores in the DRAM 110 beforehand information about the position of the zoom lens (zoom lens position), the position of the focus lens (focus lens position), and the degree of focusing (as described below) which precede the movement to the wide angle side, and the direction of lens movement during the focal point adjustment performed before the zoom lens is moved to the wide angle side. In this exemplary embodiment, the moving direction of the focus lens during the focal point adjustment performed before the zoom lens is moved to the wide angle side is a final moving direction of the focus lens in the continuous AF performed in S201.

By moving the position of the zoom lens to the wide angle side, an object having gone out of the view angle can be captured again in the view angle as illustrated in FIG. 8D although the object is reduced in size as illustrated in FIG. 8C. In this exemplary embodiment, even after the object is captured again, the zoom is maintained at the wide angle side until the system control unit 112 determines that the camera is stationary. Until then, the continuous AF is carried out (step S204).

After that, in step S205, the system control unit 112 determines whether the state of the SW1 118 has been maintained. In the case where the state of the SW1 118 has been maintained, the process returns to step S205. In the case where the state of the SW1 118 has not been maintained, the process proceeds to step S206. Here, where the state of the SW1 118 has not been maintained, the SW2 119 has been operated, or the operation of the SW1 118 has been stopped. In step S206, it is determined whether the imaging is being performed by the SW2 119 or the like. If it is determined that the imaging is being performed, the flow of the frame-out preventive control is ended. If it is determined that the imaging is not being performed, the process proceeds to step S207. In step S207, the system control unit 112 acquires the amount of movement of the camera using the angular speed sensor unit 121, and determines whether the camera is being moved, for example, being panned. If the camera is being moved, the process returns to step S204. If the camera is stationary, the process proceeds to step S208.

In step S208, the system control unit 112 moves the zoom lens position and the focus lens position to the zoom lens position and the focus lens position set in step S203 or preceding steps. Concretely, the system control unit 112 moves the zoom lens position and the focus lens position to the zoom lens position and the focus lens position that are stored in the DRAM 110. Therefore, as illustrated in FIG. 8E, while the object is captured again in the view angle, the zoom lens position and the focus lens position can be moved back (zoom in) to the zoom lens position and the focus lens position that are assumed before the zoom lens position is moved to the wide angle side.

After that, in step S209, the system control unit 112 resumes the continuous AF. Incidentally, it is assumed that the continuous AF in step S201 and step S209 can be set to an ON state or an OFF state as desired by the operator using the operation unit 115.

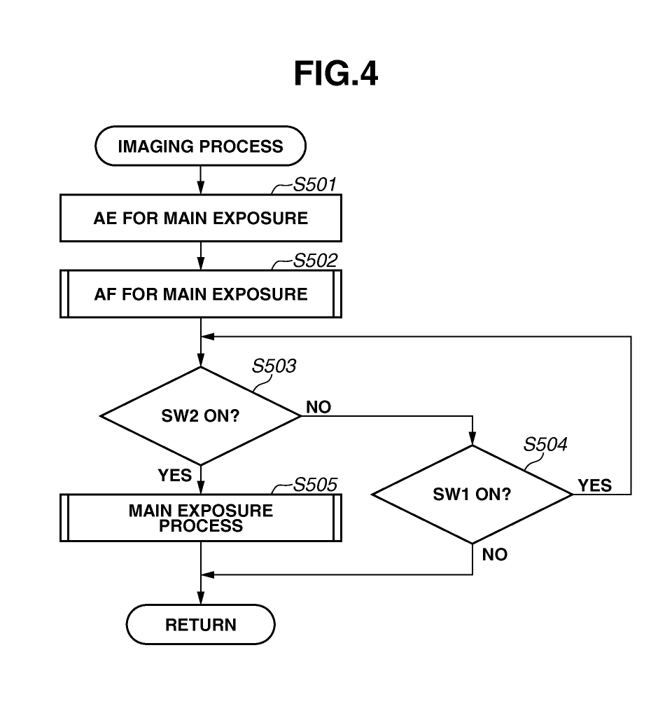

In step S210, the system control unit 112 determines the state (ON or OFF) of the SW1 118 that is used for commanding an imaging preparation. If the state of the SW1 118 is ON, the system control unit 112 performs the imaging standby operation, and then executes an imaging process (as described below with reference to FIG. 4). Then, the process ends.

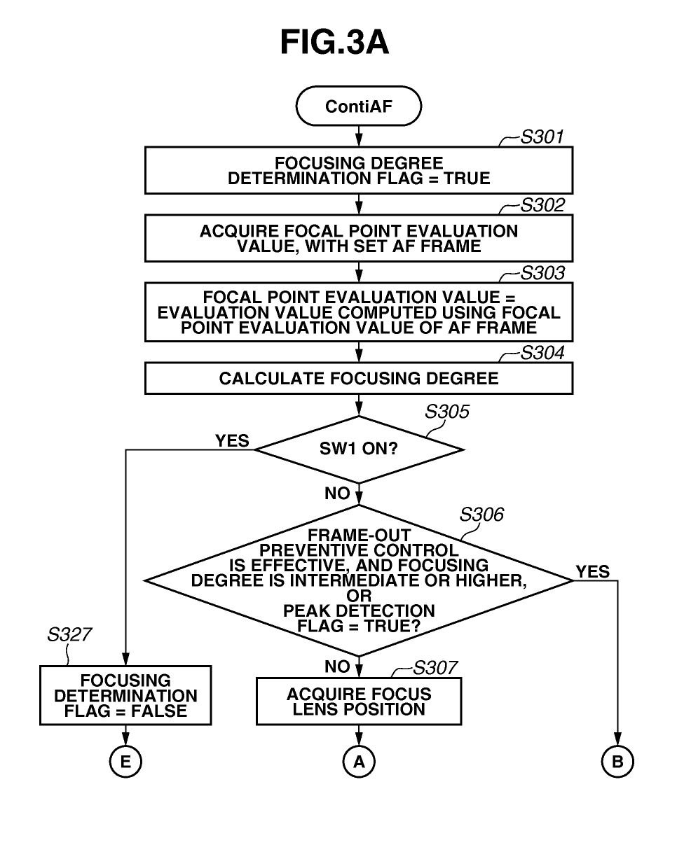

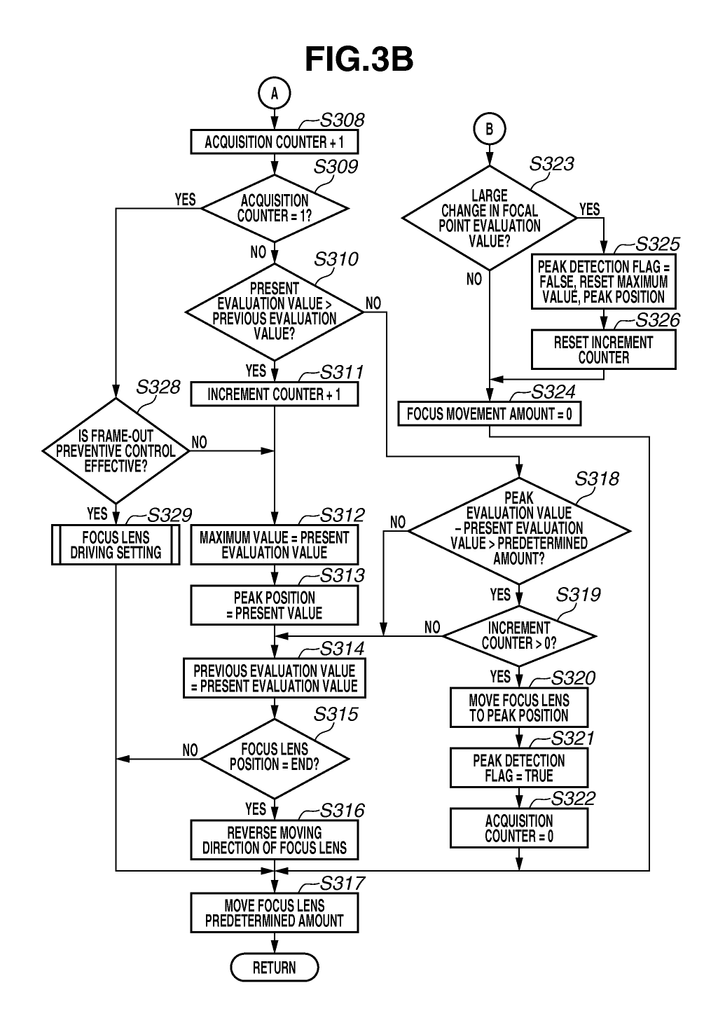

Next, the continuous AF in steps S201, S204 and S209 in the flowchart in FIG. 2 will be described in detail with reference to a flowchart illustrated in FIGS. 3A and 3B.

Firstly, in step S301, the system control unit 112 sets a focusing degree determination flag to TRUE.

In step S302, the system control unit 112 acquires a focal point evaluation value, using the set AF frame. Here, the AF frame refers to an object region in the screen about which a focal point evaluation value is acquired. Furthermore, the focal point evaluation value refers to a value obtained by converting an analog video signal read out from the imaging sensor 106 into a digital signal through the use of the A/D conversion unit 107 and then extracting from the output of the A/D conversion unit 107 a high-frequency component of a luminance signal through the use of the image processing unit 108. The system control unit 112 associates the position of the focus lens 104 and the AF frame position with each other, and stores the position of the focus lens 104 and the AF frame position in a memory in the system control unit 112. Acquiring a focal point evaluation value means that the AF processing unit 105 reads out a focal point evaluation value stored in the memory for the purpose of making a determination in the AF control. An AF frame can be arbitrarily set in various manners, for example, on a human face, in the vicinity of the center of the view angle, etc. The number of AF frames set may be one, or two or more. In this exemplary embodiment, one or more AF frames are set at a predetermined size in the vicinity of the center.

In step S303, the system control unit 112 sets the evaluation value computed from the focal point evaluation value of the set AF frame, as a focal point evaluation value that is used in step S304 and subsequent steps. In the exemplary embodiment, a value obtained by dividing the maximum value A in the AF frame which is obtained by the AF processing unit 105, by a difference between the maximum and minimum values of the luminance in the AF frame is used as a degree of focusing.

In step S304, the system control unit 112 calculates a degree of focusing on the basis of the focal point evaluation value. In this exemplary embodiment, the degree of focusing is determined as one of three levels, that is, high, intermediate and low levels, on the basis of the focal point evaluation value obtained in S303. Furthermore, if the degree of focusing at the zoom lens position in and prior to step S203 is the intermediate or high level, the degree of focusing obtained at the zoom lens position in and prior to step S203 is used as an initial degree of focusing after step S203 and after step S208.

In step S305, the system control unit 112 determines the state (ON/OFF) of the SW1 118 that commands the imaging preparation. If the state of the SW1 118 is ON (on-state), the process proceeds to step S327, in which the focusing degree determination flag is set to FALSE. Then, the process ends. If the state of the SW1 118 is OFF (off-state), the process proceeds to step S306.

In step S306, the system control unit 112 determines whether the frame-out preventive control is in the effective state and the degree of focusing is at the intermediate or higher level, or whether a peak detection flag is TRUE. If the peak detection flag is TRUE, the process proceeds to step S323. If the peak detection flag is FALSE, the process proceeds to step S307.

In step S307, the system control unit 112 acquires the present position of the focus lens 104. In step S308, the system control unit 112 adds 1 to an acquisition counter for counting the number of acquisitions of the focal point evaluation value and acquisitions of the present position of the focus lens 104. This acquisition counter is set to 0 beforehand in an initializing operation (not illustrated).

In step S309, the system control unit 112 determines whether the value of the acquisition counter is 1. If the value of the acquisition counter is 1, the process proceeds to step S328.

In step S328, it is determined whether the frame-out preventive control is in the effective state. If the frame-out preventive control is in the effective state, the process proceeds to step S329. If the frame-out preventive control is not in the effective state, the process proceeds to step S312. Details of step S329 will be described later.

In step S310, the system control unit 112 determines whether the “present focal point evaluation value” is greater than the “previous focal point evaluation value”. If the “present focal point evaluation value” is greater, the process proceeds to step S311. If the “present focal point evaluation value” is not greater, the process proceeds to step S318.

In step S311, the system control unit 112 adds 1 to an increment counter.

In step S312, the system control unit 112 stores the present focal point evaluation value as a maximum value of the focal point evaluation values, in a computation memory provided within the system control unit 112.

In step S313, the system control unit 112 stores the present position of the focus lens 104 as the peak point of the focal point evaluation values, in the computation memory provided within the system control unit 112.

In step S314, the system control unit 112 stores the present focal point evaluation value as a previous focal point evaluation value, in the computation memory provided within the system control unit 112.

In step S315, the system control unit 112 determines whether the present position of the focus lens 104 is at an end of the AF frame. If the present position of the focus lens 104 is at the end of the AF frame, the process proceeds to step S316. If the present position of the focus lens 104 is not at the end, the process proceeds to step S317.

In step S316, the system control unit 112 reverses the moving direction of the focus lens 104. In step S317, the system control unit 112 moves the focus lens 104 by a predetermined amount. In the case where a setting of the driving of the focus lens where the focus movement amount=0 has been made in step S324, or step S905, step S910 or step S911 of step S329, the predetermined amount in step S317 is 0.

In this exemplary embodiment, the aforementioned movement amount is usually set large if a defocus state continues for a predetermined time. However, in the case where the frame-out preventive control is in the effective state, this condition for increasing the movement amount is restricted, by taking into account that if an object is moving within the view angle during the effective state of the frame-out preventive control, the AF can be incorrectly performed to move the focus to an incorrect focus position, so that defocus will be conspicuous. To restrict this condition, it is sufficient to, for example, adopt a method in which the threshold value of the degree of focusing is changed, a method in which the threshold value of the length of time for determining that the object is out of focus for a predetermined time is set to a relatively large value. Furthermore, the condition is more strictly restricted if the movement amount of the object is large. Still further, the threshold value of the degree of focusing may be changed according to the aperture value or the brightness of an object. For example, it is conceivable to reduce the threshold value if the aperture is greatly reduced, or to set the threshold value lower the greater the aperture value. Furthermore, it is conceivable to reduce the threshold value if the object is dark (the brightness of the object is low), or to set the threshold value lower the darker the object of a scene. Thus, by changing the setting of the threshold value, the focus movement amount can be kept small or made large (transition to a so-called hill-climbing control state can be made). Furthermore, when the amount of movement of the object is greater than or equal to a predetermined value, the focus movement amount may be set smaller than that at the time when the amount of movement of the object is smaller than the predetermined value.

In step S318, the system control unit 112 determines whether “the maximum focal point evaluation value—the present focal point evaluation value” is greater than a predetermined value. If “the maximum focal point evaluation value—the present focal point evaluation value” is greater than the predetermined value, the process proceeds to step S319. If it is not greater than the predetermined value, the process proceeds to step S314. It is to be noted here that if “the maximum focal point evaluation value—the present focal point evaluation value” is greater than the predetermined value, that is, if the focal point evaluation value has presently become smaller than the maximum value by the predetermined value, the maximum value is regarded as the value at the peak point of focus.

In step S319, the system control unit 112 determines whether the increment counter is greater than 0. If the increment counter is greater than 0, the process proceeds to step S320. If the increment counter is not greater than 0, the process proceeds to step S314.

In step S320, the system control unit 112 moves the focus lens 104 to the peak point stored in step S313 at which the focal point evaluation value became the maximum value. In step S321, the system control unit 112 sets the peak detection flag to TRUE. In step S322, the system control unit 112 clears the acquisition counter to 0.

In step S323, the system control unit 112 determines whether the present focal point evaluation value has changed from the maximum focal point evaluation value by at least a predetermined proportion of the maximum value. If the present focal point evaluation value has changed from the maximum value by the predetermined proportion or more, the process proceeds to step S325. If the present focal point evaluation value has not changed from the maximum value by the predetermined proportion or more, the process proceeds to step S324.

In step S324, the system control unit 112 sets the focus movement amount of the focus lens 104 to 0.

In step S325, the system control unit 112 sets the peak detection flag to FALSE, and resets the maximum value and the peak point of the focal point evaluation value, in order to acquire again a focus lens position at which the focal point evaluation value is maximum. In step S326, the system control unit 112 resets the increment counter.

Thus, in the continuous AF operation, the focus lens 104 is driven such that a main object is always in focus. In other words, even if the object slightly moves within the view angle, the object is brought into focus by moving the focus lens 104.

Next, the imaging process in step S210 in the flowchart illustrated in FIG. 2 will be described with reference to a flowchart illustrated in FIG. 4. In this operation, the SW1 118, which commands the imaging preparation, is in the ON state.

Firstly, in step S501, the system control unit 112 performs an AE process for main exposure, using the AE processing unit 103. In step S502, the system control unit 112 performs the AF for main exposure, using the AF processing unit 105 and following a procedure as described below.

In step S503, the system control unit 112 determines the state (ON/OFF) of the SW2 119, which is provided to command the imaging. If the state of the SW2 119 is ON, the process proceeds to step S505. If the state of the SW2 119 is OFF, the process proceeds to step S504.

In step S504, the system control unit 112 determines the state (ON/OFF) of the SW1 118, which is provided to command the imaging preparation. If the state of the SW1 118 is ON, the process proceeds to step S503. If the state of the SW1 118 is OFF, this imaging process ends. In step S505, the system control unit 112 performs the main exposure, following the procedure as described later. After that, the imaging process ends.

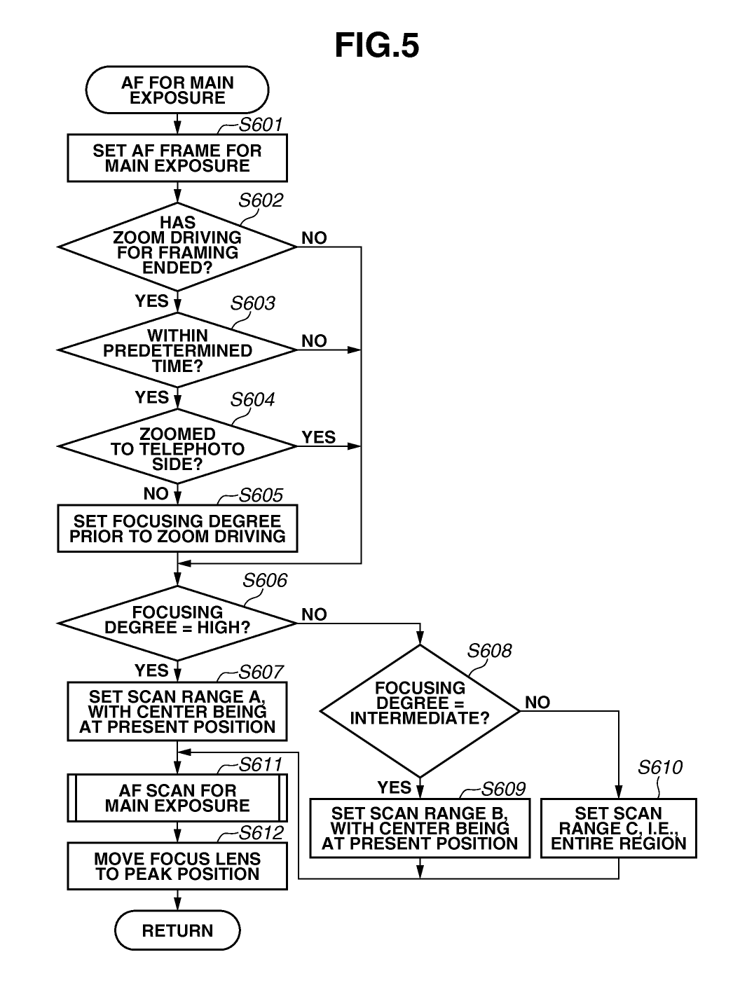

Next, the AF for main exposure in step S502 in the flowchart illustrated in FIG. 4 will be described with reference to a flowchart illustrated in FIG. 5.

Firstly, in step S601, the system control unit 112 sets an AF frame for main exposure. The frame setting in this step is made at a predetermined size, near the center. In step S602, the system control unit 112 determines whether the zoom driving for framing (step S208) has been completed. If the zoom driving for framing has been completed, the process proceeds to S603. If the zoom driving for framing has not been completed, the process proceeds to S606.

In step S603, the system control unit 112 measures the time from when the zoom driving for framing is performed and to when the AF for main exposure is executed. If the measured time is shorter than or equal to a predetermined time, the process proceeds to step S604. If the measured time is longer than the predetermined time, the process proceeds to step S606. In step S604, the system control unit 112 determines whether in step S206, the zoom position has been shifted to the telephoto side. If zoom position has been shifted to the telephoto side, the process proceeds to step S606. If not, the process proceeds to S605. In step S605, the degree of focusing is updated with the degree of focusing calculated in the continuous AF in S201, which has been executed prior to step 202.

In step S606, the system control unit 112 determines whether the degree of focusing set in step S304 or step 605 is “high”. If the degree of focusing is “high”, the process proceeds to step S607. If the degree of focusing is not “high”, the process proceeds to step S608.

In step S607, the system control unit 112 sets a scan range A whose center is at the present position of the focus lens 104. In this step, the system control unit 112 determines that, due to the continuous AF operation, the main object is substantially in focus, that is, the focus lens 104 is positioned near the in-focus position at which the focal point evaluation value peaks, and then sets a narrow scan range.

In step S608, the system control unit 112 determines whether the aforementioned degree of focusing is “intermediate”. If the degree of focusing is “intermediate”, the process proceeds to step S609. If the degree of focusing is not “intermediate”, the process proceeds to step S610.

In step S609, the system control unit 112 sets a scan range B whose center is at the present position of the focus lens 104. In this step, the system control unit 112 determines that although, due to the continuous AF operation, the focus lens 104 is positioned near the in-focus position, the degree of focusing has not been raised to a “high” state, and therefore sets a range that is broader than the scan range A.

In step S610, the system control unit 112 sets a scan range C that is the entire of a AF-implementable range stored in advance.

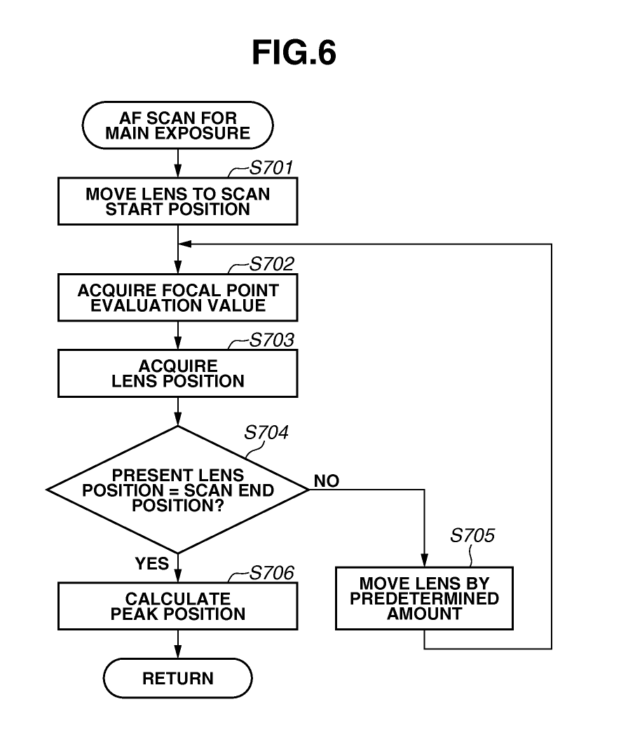

In step S611, the system control unit 112 performs AF scan for main exposure, following a procedure as described below. In step S612, the system control unit 112 moves the focus lens 104 to a peak point calculated in step S706 in a flowchart illustrated in FIG. 6 (as described below).

Next, the AF scan for main exposure in step S611 in the flowchart illustrated in FIG. 5 will be described with reference to the flowchart in FIG. 6.

Firstly, in step S701, the system control unit 112 moves the focus lens 104 to a scan start position. The scan start position here is an end position of the scan range set in step S607, S609 or S610 in FIG. 5.

In step S702, according to the command from the system control unit 112, the A/D conversion unit 107 converts an analog video signal read out from the imaging sensor 106 into a digital signal, and the image processing unit 108 extracts a high-frequency component of a luminance signal from the output of the A/D conversion unit 107. The system control unit 112 stores the extracted high-frequency component as a focal point evaluation value in the memory provided within the system control unit 112.

In step S703, the system control unit 112 acquires the present position of the focus lens 104, and stores the position data in the memory provided within the system control unit 112.

In step S704, the system control unit 112 determines whether the present position of the focus lens 104 is a scan end position. If the focus lens 104 is presently at the scan end position, the process proceeds to step S706. If the focus lens 104 is not presently at the scan end position, the process proceeds to step S705. In step S705, the system control unit 112 moves the focus lens 104 toward the scan end position by a predetermined amount. Then, the process goes back to step S702.

In step S706, the system control unit 112 calculates the peak point of the focal point evaluation value from the focal point evaluation value and the lens position corresponding to the focal point evaluation value stored in step S702 and step S703, respectively.

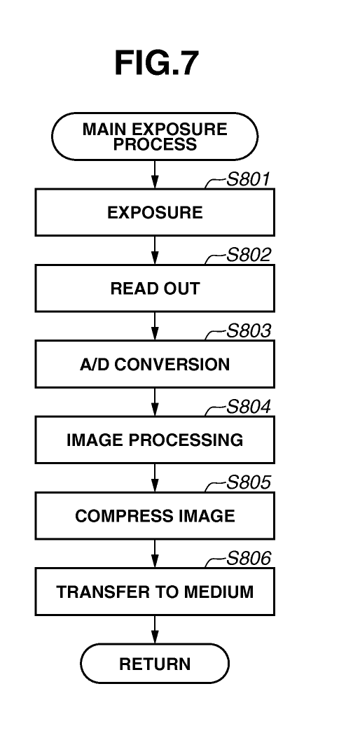

Next, the main exposure process in step S505 in the flowchart illustrated in FIG. 4 will be described with reference to a flowchart in FIG. 7.

In step S801, the imaging sensor 106 is exposed to light. Then, in step S802, the system control unit 112 reads out data accumulated in the imaging sensor 106. In step S803, according to a command from the system control unit 112, the A/D conversion unit 107 converts an analog signal read out from the imaging sensor 106 into a digital signal.

In step S804, according to a command from the system control unit 112, the image processing unit 108 performs various kinds of image processing on the digital signal output by the A/D conversion unit 107.

In step S805, according to the command from the system control unit 112, the format conversion unit 109 compresses the image processed in step S804, according to a format, such as the Joint Photographic Experts Group (JPEG).

In step S806, according to a command from the system control unit 112, the image recording unit 111 receives and records data compressed in step S805.

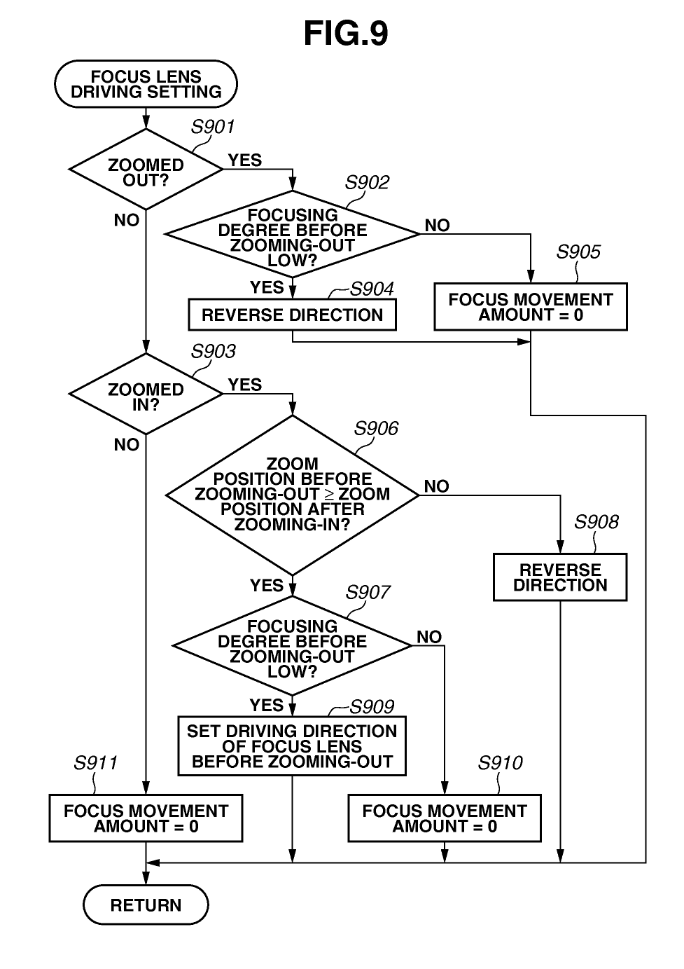

Next, the focus lens driving setting in step S329 in the flowchart illustrated in FIG. 3B will be described with reference to a flowchart in FIG. 9.

Firstly, in step S901, the system control unit 112 determines whether zooming-out has been performed in the frame-out preventive control. If zooming-out has been performed, the process proceeds to step S902. If zooming-out has not been performed, the process proceeds to step S903. In step S902, it is determined whether the degree of focusing before zooming-out that is stored in the DRAM 110 is lower than a predetermined threshold value. If the degree of focusing is lower than the predetermined threshold value, the process proceeds to step S904. If the degree of focusing is not lower than the predetermined threshold value, the process proceeds to step S905. In step S904, the moving direction of the focus lens is reversed from the previously set direction. Then, the process ends. The reason for the reversal is because a control of searching for an in-focus position from an initial state is performed, taking into account that the view angle has changed due to the zooming-out. If a fixed moving direction of the focus lens is set in the initial state, many restarts of the continuous AF due to a zoom operation or the like will continually shift the focus in a predetermined single direction. Therefore, the reversal in direction is performed for the purpose of starting the search from the same focus point as much as possible in the initial state. In step S905, the focus movement amount is set to 0. Then, the process ends. In the case where the frame-out preventive control is in the effective state, it is highly likely that a moving object is being framed; therefore, taking into incorrect AF or the like, the focus lens is kept unmoved as in step S905 to reduce useless continuous focusing. In step S903, it is determined whether zooming-in has been performed. If zooming-in has not been performed, the process proceeds to step S911, in which the focus movement amount is set to 0. Then, the process ends. If zooming-in has been performed, the process proceeds to step S906. In step S906, if the zoom position after zooming-in is at the wide angle side of the zoom position before zooming-out or at the same position as the zoom position before zooming-out, the process proceeds to step S907. If the zoom position after zooming-in is at the telephoto side of the zoom position before zooming-out, the process proceeds to step S908. In step S908, the moving direction of the focus lens is reversed as in step S904. The reason for the reversal in direction is the same as that for the reversal in step S904. In step S907, it is determined whether the degree of focusing before zooming-out that is stored in the DRAM 110 is low. If the degree of focusing is low, the process proceeds to step S909, in which the driving direction of the focus lens before zooming-out that is stored in the DRAM 110 is set. Then, the process ends. The reason for adopting the stored moving direction of the focus lens is because a result of the past continuous focusing is used, taking into account the possibility that the view angle returns to the view angle before zooming-out. If in step S907 it is not determined that the degree of focusing is low, the process proceeds to step S910 on the assumption that continuous focusing has been performed to some extent at the previous zoom position (view angle). In step S910, the focus movement amount is set to 0. Then, the process ends.

Due to the operation as described above, in the case where the object has been in focus at the telephoto side, when the zoom lens position returns from the wide angle side to the telephoto side (when such a telephoto-side zoom lens position is set as a target position), the focus lens can be moved by using as a target position the focus position that corresponds to the previous distance of the object.

As can be understood from the foregoing description, according to the exemplary embodiment, panning is detected by the movement detection regarding the camera, and even when an object goes out of the view angle at the time of telephoto imaging, it is possible to prevent an object from falling out of focus after view angle adjustment. Then, during an imaging preparation, it is possible to quickly focus on a main object that needs to be brought into focus.

For example, in the case where after an object temporarily goes out of the view angle in a telephoto imaging scene, zoom to the wide angle side is performed and then the view angle is adjusted, the object can be quickly brought into focus at the time point when the zoom position is returned to the telephoto side. Furthermore, immediately after the zoom driving to the wide angle side is performed while the frame-out preventive control is performed, continuous AF is started from a state in which the focus lens is stopped (monitoring state) if the degree of focusing prior to the zoom driving is greater than or equal to a predetermined threshold value. Furthermore, if the degree of focusing before zoom-driving is performed is not greater than or equal to the predetermined threshold value, the continuous AF is started with small driving (wobbling). In other words, when the degree of focusing is a first degree of focusing, the range in which the focus lens is driven is made smaller than that at the time when the degree of focusing is a second degree of focusing that is smaller than the first degree of focusing, so that the object can be quickly brought into focus even at the wide angle side.

Therefore, even in the case where the scene for imaging has changed, it is possible to prevent an object that needs to be bought into focus from falling out of focus during the imaging preparation.

Although the preferred exemplary embodiments of the present invention have been described, the present invention is not limited to these exemplary embodiments, but can be modified and changed in various manners within the scope of the gist of the present invention.

For example, in the foregoing exemplary embodiments, the zoom lens position is shifted to the wide angle side by pressing down the zoom operation unit 120 provided as an operation unit for assisting in the view angle adjustment, and the zoom lens position is shifted to the telephoto side by releasing the pressing-down of the zoom operation unit 120. However, the present invention is not limited to this case. For example, the moving of the zoom lens position to the wide angle side or the moving of the zoom lens position to the telephoto side may be performed by using a plurality of operation units.

Furthermore, in the present exemplary embodiments, movement detection (panning detection) regarding the camera is performed, and if the camera is panned, the zoom position is shifted to the wide angle side, and when the movement of the camera stops still, the zoom position is returned to the telephoto side. However, the operation of shifting the zoom position to the wide angle side or returning the zoom position to the telephoto side may be controlled by determining the state of operation of the zoom operation unit 120 performed by an operator. Concretely, the system control 112 unit determines whether the zoom operation unit 120 has been pressed down (subjected to a first operation). If the zoom operation unit 120 is operated, the zoom position is moved to the wide angle side in order to facilitate the view angle adjustment. After that, the system control unit 112 determines whether the pressing-down of the zoom operation unit 120 has been discontinued (subjected to a second operation), that is, the operator has released the zoom operation unit 120. Then, if the pressing-down of the zoom operation unit 120 is released, the system control unit 112 moves the zoom position to the previous position at the telephoto side. It is to be noted herein that when the operator releases the pressing-down of the zoom operation unit 120 is considered to be when the object is captured substantially at the center of the view angle.

With the configuration and operations described above, it becomes possible to capture again an object by a simple operation even in the case where the object goes out of the view angle at the time of telephoto imaging, and to focus on an object while adjusting the view angle even in the case where the object moves in a direction of distance during the view angle adjustment. It should also be noted in the description above, the object is brought into focus by moving (driving) the focus lens. Although, as described above, the object may change position (or even exit from) within the angle of view, the object itself is not moved to be brought into focus.

### Other Embodiments

Certain embodiment(s), or at least part of the embodiments, of the present invention can be implemented by a specifically programmed computer of a system or apparatus that reads out and executes computer executable instructions (e.g., one or more programs that implement one or more of the algorithms of FIGS. 2-7) recorded on a storage medium (which may also be referred to more fully as a ‘non-transitory computer-readable storage medium’). That is, a programmed computer may be provided to perform the functions of one or more of the above-described embodiment(s); and/or one or more circuits (e.g., application specific integrated circuit (ASIC)) may be provided for performing the functions of one or more of the above-described embodiment(s). Therefore, a method or process can be performed by the computer of the system or apparatus by, for example, reading out and executing the computer executable instructions from the storage medium to perform the functions of one or more of the above-described embodiment(s); and/or the method or process can be implemented by controlling the one or more circuits to perform the functions of one or more of the above-described embodiment(s). The computer may comprise one or more processors (e.g., central processing unit (CPU), micro processing unit (MPU)) and may include a network of separate computers or separate processors operatively connected to storage media (memory) and programmed to read out and execute the computer executable instructions stored in the memory. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest reasonable interpretation so as to encompass all modifications and equivalent structures and functions.

This application claims the priority benefit of Japanese Patent Application No. 2014-022453 filed Feb. 7, 2014, which is hereby incorporated by reference herein in its entirety.

What is claimed is:

1. A focus adjustment apparatus for controlling a position of a lens, comprising:
a control unit configured to shift a zoom position of the lens to a wide angle side according to a first operation condition of the apparatus, and to shift the zoom position to a telephoto side according to a second operation condition of the apparatus;
a storage unit configured to store the zoom position and a focus position when the zoom position is shifted to the wide angle side by the control unit; and
a focal point adjustment unit configured to bring an object into focus by moving a focus lens to a target position,
wherein, when the zoom position is moved to the telephoto side by the control unit, the zoom position stored in the storage unit is used as the target position, and
wherein, when the zoom position is being shifted to the wide angle side by the control unit, the focal point adjustment unit brings the object into focus by moving the focus lens and uses as the target position the focus position stored in the storage unit.

2. The focal point adjustment apparatus according to claim 1, further comprising a detection unit configured to an operation condition of the apparatus based on shake information detected by a shake detection unit,
wherein the first operation condition is a panning operation whose presence or absence is determined by the detection unit.

3. The focal point adjustment apparatus according to claim 2, wherein the control unit shifts the zoom position to the wide angle side if it is determined that the panning operation is being performed.

4. The focal point adjustment apparatus according to claim 2, wherein the control unit shifts the zoom position to the telephoto side if it is determined that the panning operation is not being performed.

5. The focal point adjustment apparatus according to claim 1, wherein, if a degree of focusing before the zoom position is shifted to the wide angle side by the control unit is greater than or equal to a predetermined value, after the zoom position is shifted to the telephoto side by the control unit, the focal point adjustment unit moves the focus position to a focus position before the zoom position is shifted to the wide angle side.

6. The focal point adjustment apparatus according to claim 5, wherein the predetermined value of the degree of focusing set when an aperture value is a second aperture value that is greater than a first aperture value is lower than the predetermined value set when the aperture value is the first aperture value.

7. The focal point adjustment apparatus according to claim 5, wherein the predetermined value of the degree of focusing set when brightness of the object is a second brightness that is darker than a first brightness is lower than the predetermined value set when the brightness of the object is the first brightness.

8. The focal point adjustment apparatus according to claim 1, wherein when the zoom position is shifted to the wide angle side by the control unit, the storage unit stores at least one of a degree of focusing and a final moving direction of the focus lens in a focal point adjustment performed before the zoom position is shifted to the wide angle side.

9. The focal point adjustment apparatus according to claim 1, wherein, in a focal point adjustment performed when the zoom position is shifted to the telephoto side by the control unit, a direction of focusing is a direction determined in a focal point adjustment performed before the zoom position is shifted to the wide angle side by the control unit.

10. A method for controlling a position of a lens with focus adjustment apparatus, the method comprising:
changing a zoom position of the lens to a wide angle side according to a first operation condition of the apparatus, and changing the zoom position to a telephoto side according to a second operation condition of the apparatus;
storing the zoom position and a focus position of the lens when the zoom position is shifted to the wide angle side; and
performing a focal point adjustment in which an object is brought into focus by moving a focus lens to a target position,
wherein, when the zoom position is moved to the telephoto side, the zoom position stored in the storing is used as the target position, and
wherein, in the focal point adjustment, when the zoom position is being shifted to the wide angle side, the object is brought into focus by moving the focus lens and the focus position stored in the storing is used as the target position.
